(19) United States
(12) Patent Application Publication
(10) Pub. No.: US 2020/0261306 A1
(43) Pub. Date: Aug. 20, 2020

(54) HANDHELD MASSAGE DEVICE

(71) Applicant: Thomas F. Pepe, Bradenton, FL (US)

(72) Inventor: Thomas F. Pepe, Bradenton, FL (US)

(73) Assignee: TT Therapeutics, LLC, Missouri City, TX (US)

(21) Appl. No.: 16/869,285

(22) Filed: May 7, 2020

Related U.S. Application Data
(63) Continuation-in-part of application No. 15/493,361, filed on Apr. 21, 2017.

(51) Int. Cl. A61H 23/00; A61H 23/02

(52) U.S. Cl. CPC A61H 23/006; A61H 23/0254; A61H 2201/0153; A61H 2201/5038; A61H 2201/0207; A61H 2201/0214; A61H 2201/5035; A61H 2201/0157

(57) ABSTRACT

A handheld massage device is disclosed. The massage device comprises a housing defining a base, a handle portion, a motor receiving portion, a shaft portion, and a battery portion. The handle portion and the battery portion are extended vertically from both ends of the base, thereby forming an open space for enabling a user to hold the massage device, and the motor receiving portion is perpendicularly extended at a top from the handle portion. An electric motor is operatively positioned within the motor receiving portion. An applicator head is rotatably connected to the electrical motor via a shaft. The shaft portion receives the shaft and is configured to rotate up to 175 degrees, thereby enabling the user to conveniently massage the body. A battery is removably affixed within the battery portion, and is electrically connected to the electric motor via a trigger for supplying electrical power to operate the massage device.

### CROSS-REFERENCE TO RELATED APPLICATION

This application is a Continuation in parts for patent application Ser. No. 15/493,361 titled “HANDHELD MASSAGE DEVICE” filed on Apr. 21, 2017. The specification of the above referenced patent application is incorporated herein by reference in its entirety

### BACKGROUND OF THE INVENTION

### A. Technical Field

The present invention generally relates to a massage device. Specifically, the present invention relates to a massage device designed to provide a variety of therapeutic experiences to a user by employing novel massaging heads, which are subjected to variable motion patterns.

### B. Description of Related Art

Massage is the beneficial practice of tissue manipulation. By way of example, massage can provide therapeutic advantages, alleviate pain, stimulate circulation, relieve tension, provide flexibility to muscles and joints, and improve range of motion, and so forth. Additionally, massage can provide psychological benefits such as lessening depression and anxiety and increasing sleep quality.

Generally, massage therapists apply various techniques when treating an individual, dependent upon the condition of the individual. Some therapists have made use of various tools designed to more effectively and/or more easily apply various therapeutic techniques. Some tools may improve some aspects related to applying a particular therapy, while sometimes making other aspects worse. Other tools may fall short of the desired effect, or may be the victim of ever-increasing demands that they were never intended to meet and/or address. Consequently, there is an ever-increasing demand to develop more effective techniques, some of which may only be possible with an appropriate tool. Furthermore, there is a demand to increase the effectiveness of existing tools.

Currently, people using different kind of massage devices and tools for experiencing therapeutic massage. However, the conventional massage devices and tools are manufactured and used in various forms according to the massage area. The conventional massage tools and devices are expensive, large, relatively heavy, and tethered to an electrical power source. The conventional massage devices do not support different massage heads to experience massage techniques for example, hot, cold, vibratory, and percussive therapeutic techniques. Further, the conventional massage devices may require users to hold with both hands while using and are relatively noisy.

Accordingly, there is a need for a handheld massage device used to simply and conveniently apply massage on any desired part of the user's body. Further, there is also a need for a handheld massage device, which is extremely stable in operation, inexpensive, simple to set up with minimal effort, small in size, functions efficiently, and reliably to massage any desired part of the user's body.

### SUMMARY OF THE INVENTION

The present invention generally discloses a massage device. The present invention directed to a massage device designed to provide a variety of therapeutic experiences to a user by employing novel massaging heads, which are subjected to variable motion patterns.

In one embodiment, the massage device is configured to enable the user to conveniently massage any part of the body. The user could simply and detachably connect a massage head to the massage device without any hesitation. In one embodiment, the massage device comprises a housing. In one embodiment, the housing is defining a base, a handle portion, a motor receiving portion, a shaft portion, and a battery portion. In one embodiment, the handle portion and the battery portion are extended vertically from both ends of the base, thereby forming an open space for enabling the user to simply hold the massage device. In one embodiment, the motor receiving portion is perpendicularly extended at a top from the handle portion. In one embodiment, the electric motor is a brushless motor and is configured to operate at different operational modes of the massage device. In one embodiment, the housing is made of a material, but not limited to, antimicrobial plastic.

In one embodiment, the massage device further comprises an electric motor, an applicator head, a battery. In one embodiment, the electric motor is securely and operatively positioned within the motor receiving portion of the housing. In one embodiment, the applicator head is rotatably connected to the electrical motor via a shaft. The applicator head is configured to be vibrated and heated selectively and incrementally to provide percussion and hot therapeutic effects for the user while massaging the body, thereby effectively relieving muscle soreness. In one embodiment, the massage device is further configured to use with the applicator head that is further configured to be cooled selectively and incrementally to provide percussion and cool therapeutic effects for the user while massaging the body. In one embodiment, the shaft is securely disposed within the shaft portion, which is configured to rotate up to 175 degrees, thereby comfortably reaching user's back for massaging using the massage device. In one embodiment, the shaft portion is perpendicularly and rotatably extended about a centerline of the handle portion of the housing. In one embodiment, the battery is securely and removably affixed within the battery portion of the housing. The battery is electrically connected to the electric motor via a trigger for supplying electrical power to operate the massage device at different operational modes. The battery portion comprises a recess for receiving the battery, for example, a lithium-ion battery. In one embodiment, the battery is configured to recharge using a charger, which is connected to a power supply for charging the battery.

In one embodiment, the handle portion is curved at the top portion to provide space for securely disposing the trigger. In one embodiment, the trigger is configured to enable the user to operate the massage device at different operational modes. In one embodiment, the trigger is an electronic touch-trigger. In one embodiment, the trigger is further configured to enable the user to turn on and turn off the massage device. In one embodiment, the handle portion further comprises grips on inside and outside for enabling the user to securely hold and operate the massage device. In one embodiment, the grips are preferably lined with a soft material for providing better comfort for the user in handling the massage device.

In one embodiment, the massage device further comprises an infrared sensor and a display. In one embodiment, the infrared sensor is securely disposed on the front side of the battery portion and is electrically and operatively connected to the battery via a switch. In one embodiment, the display is securely disposed on the housing and is electrically connected to the battery via conductors. The display is configured to display information related to the operational modes of the massage device and body temperature of the user, which is measured by the infrared sensor. In one embodiment, the massage device further comprises a toggle switch, which is securely disposed on the housing and is configured to enable the user to change the operational modes of the massage device.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1 shows a perspective view of a handheld massage device in an embodiment of the present invention.

FIG. 2 shows a top perspective view of the handheld massage device from one side in another embodiment of the present invention.

FIG. 3 shows a top perspective view of the handheld massage device from another side in another embodiment of the present invention.

FIG. 4 shows a side view of the handheld massage device from one side in another embodiment of the present invention.

FIG. 5 shows a side view of the handheld massage device from another side in another embodiment of the present invention.

FIG. 6 shows a front view of the handheld massage device in another embodiment of the present invention.

FIG. 7 shows a rear view of the handheld massage device in another embodiment of the present invention.

FIG. 8 shows a top view of the handheld massage device in another embodiment of the present invention.

FIG. 9 shows a bottom view of the handheld massage device in another embodiment of the present invention.

FIG. 10A shows a side view of an applicator head of the handheld massage device in one embodiment of the present invention.

FIG. 10B shows a side view of an applicator head of the handheld massage device in another embodiment of the present invention.

FIG. 10C shows a side view of an applicator head of the handheld massage device in yet another embodiment of the present invention.

FIG. 10D shows a side view of an applicator head of the handheld massage device in yet another embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

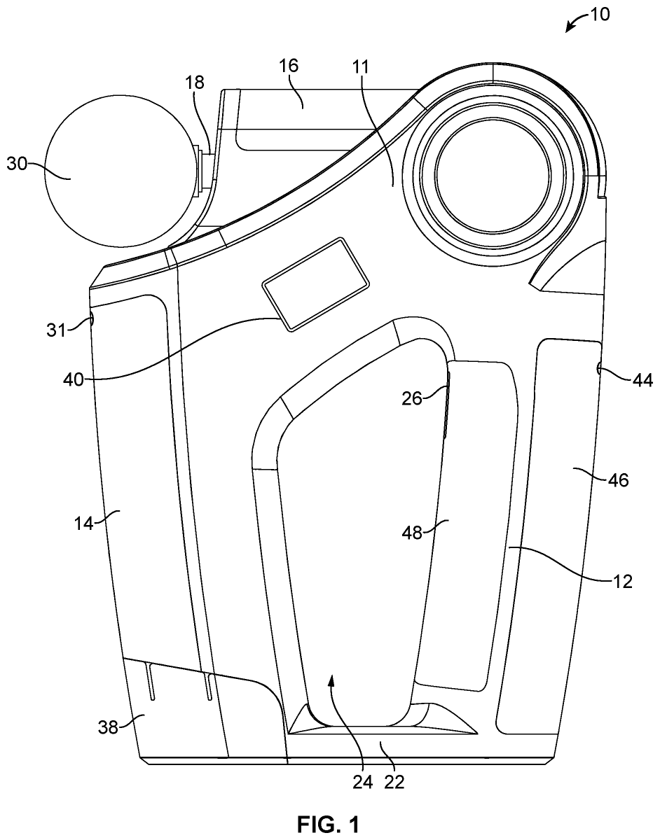

Referring to FIG. 1, a handheld massage device 10 is disclosed. In one embodiment, the massage device 10 is configured to enable the user to conveniently massage any part of the body. The user could simply and detachably connect a massage head 30 to the massage device 10 without any hesitation. In one embodiment, the massage device 10 is configured to enable the user to provide percussion, hot, and cool therapeutic effects using various massage heads for effectively relieving muscle soreness. In one embodiment, the massage device 10 produces less noise, for example, it produces a decibel value of 10 db at the lowest speed. In one embodiment, the massage device 10 comprises a housing 11. In one embodiment, the housing 11 is defining a base 22, a handle portion 12, a motor receiving portion 20, a shaft portion 16, and a battery portion 14. In one embodiment, the handle portion 12 and the battery portion 14 are extended vertically from both ends of the base 22, thereby forming an open space 24 for enabling the user to simply hold the massage device 10. In one embodiment, the motor receiving portion 20 is perpendicularly extended at a top from the handle portion 12. In one embodiment, the electric motor is a brushless motor and is configured to operate at different operational modes of the massage device 10. In one embodiment, the housing 11 is made of a material, but not limited to, antimicrobial plastic.

In one embodiment, the massage device 10 further comprises an electric motor, an applicator head 30, a battery 38. In one embodiment, the electric motor is securely and operatively positioned within the motor receiving portion 20 of the housing 11. In one embodiment, the applicator head 30 is rotatably connected to the electrical motor via a shaft 18. The applicator head 30 is configured to be vibrated and heated selectively and incrementally to provide percussion and hot therapeutic effects for the user while massaging the body, thereby effectively relieving muscle soreness. In one embodiment, the massage device 10 is further configured to use with the applicator head 30 that is further configured to be cooled selectively and incrementally to provide percussion and cool therapeutic effects for the user while massaging the body. In one embodiment, the shaft 18 is securely disposed within the shaft portion 16, which is configured to rotate up to 175 degrees, thereby comfortably reaching user's back for massaging using the massage device 10. In one embodiment, the shaft portion 16 is perpendicularly and rotatably extended about a centerline of the handle portion 12 of the housing 11. In one embodiment, the battery 38 is securely and removably affixed within the battery portion 14 of the housing 11. The battery 38 is electrically connected to the electric motor via a trigger 26 for supplying electrical power to operate the massage device 10 at different operational modes. The battery portion 14 comprises a recess for receiving the battery 38, for example, a lithium-ion battery. In one embodiment, the battery 38 is configured to recharge using a charger, which is connected to a power supply for charging the battery 38.

In one embodiment, the handle portion 12 is curved at the top portion to provide space for securely disposing the trigger 26. In one embodiment, the trigger 26 is configured to enable the user to operate the massage device 10 at different operational modes. In one embodiment, the trigger 26 is an electronic touch-trigger. In one embodiment, the trigger 26 is further configured to enable the user to turn on and turn off the massage device 10. In one embodiment, the handle portion 12 further comprises grips (46 and 48) on inside and outside for enabling the user to securely hold and operate the massage device 10. In one embodiment, the grips (46 and 48) are preferably lined with a soft material for providing better comfort for the user in handling the massage device 10.

In one embodiment, the massage device 10 further comprises an infrared sensor 31 and a display 40. In one embodiment, the infrared sensor 31 is securely disposed on the front side of the battery portion 14 and is electrically and operatively connected to the battery via a switch 44. In one embodiment, the display 40 is securely disposed on the housing 11 and is electrically connected to the battery 38 via conductors. The display 40 is configured to display information related to the operational modes of the massage device 10 and body temperature of the user, which is measured by the infrared sensor 31.

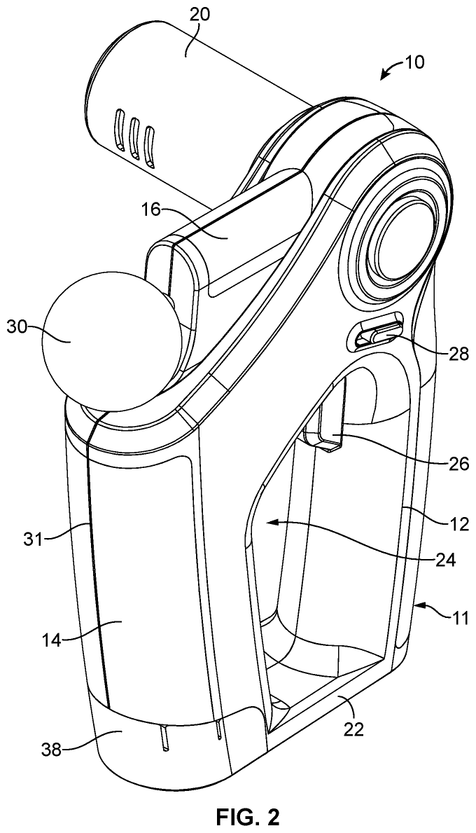

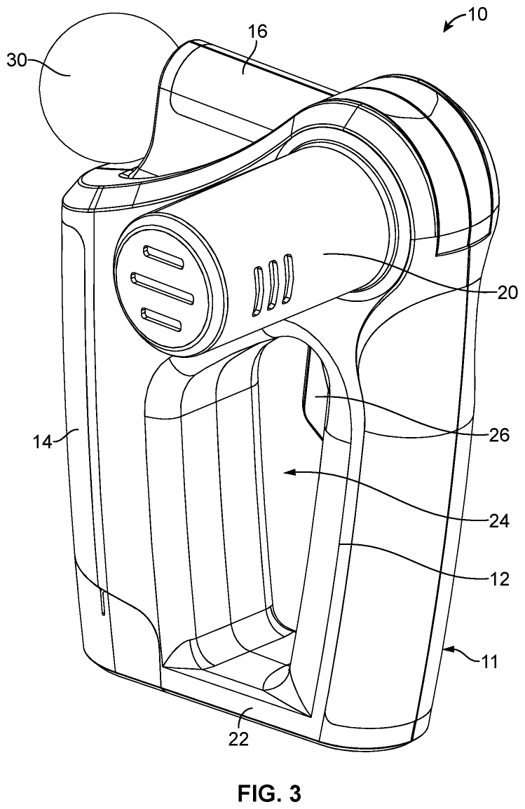

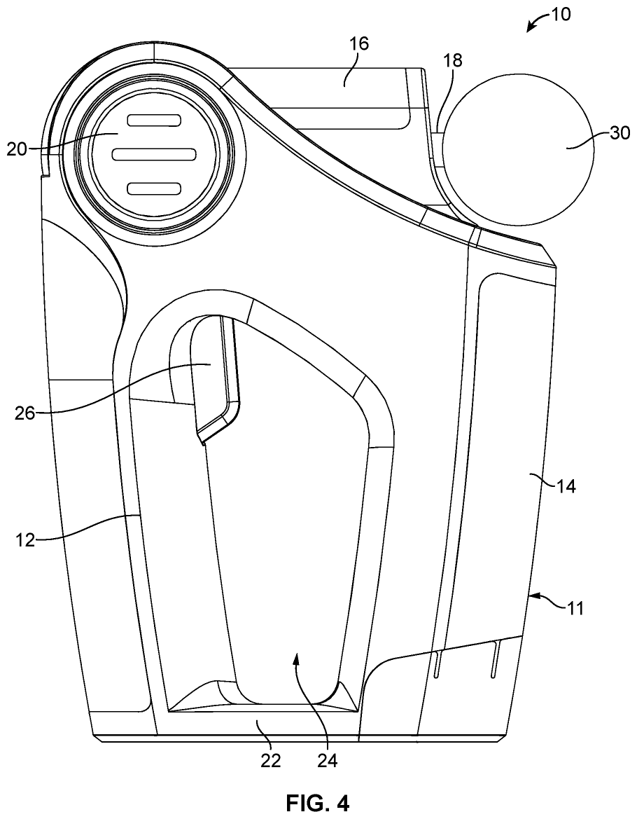

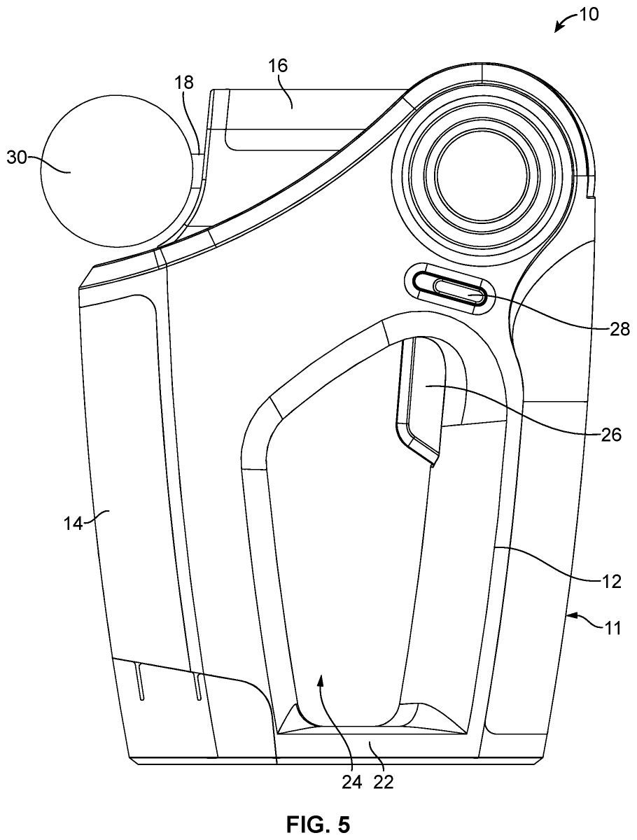

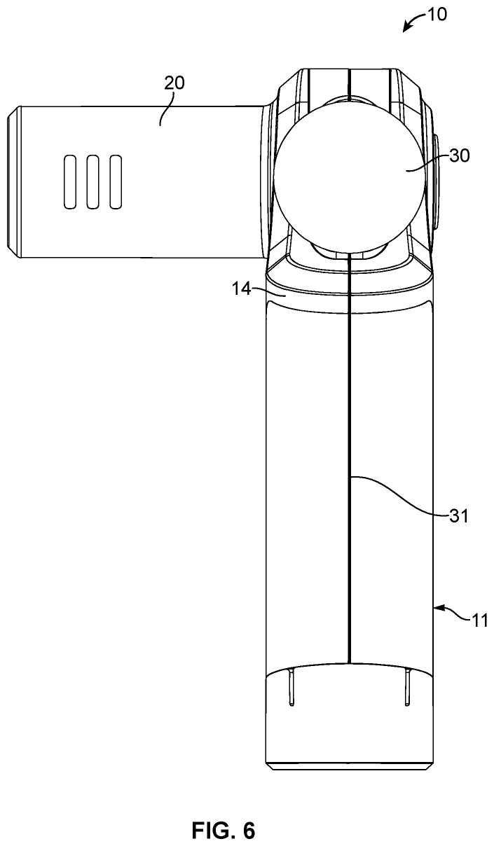

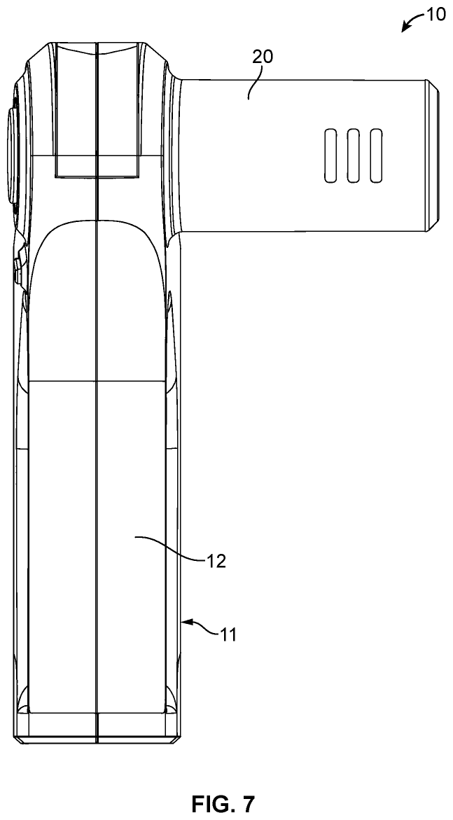

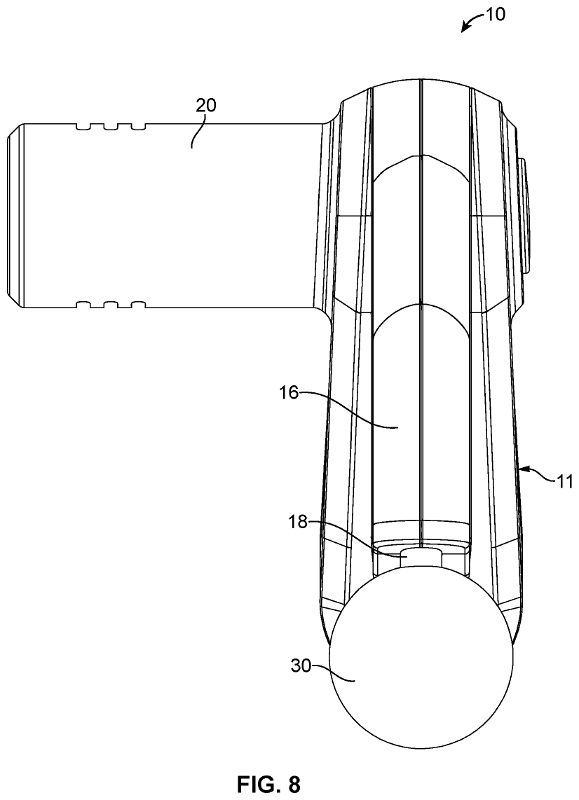

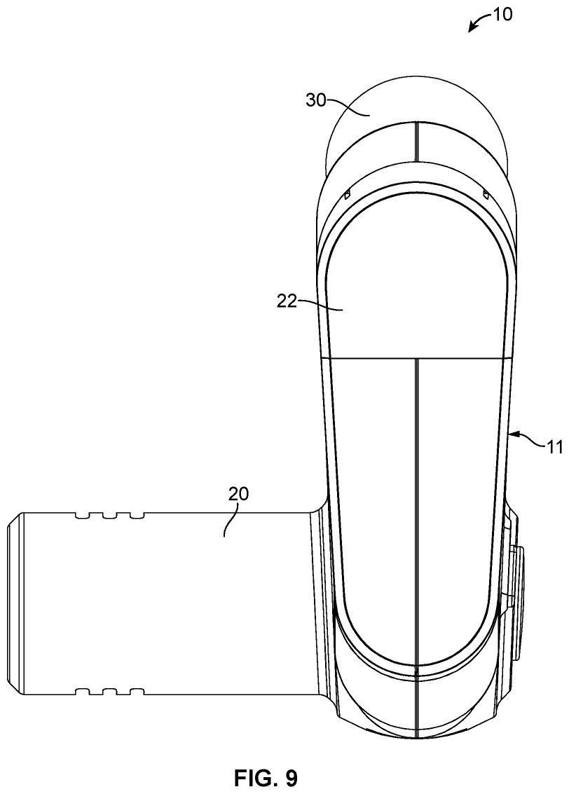

Referring to FIGS. 2-9, the handheld massage device 10 in another embodiment of the present invention is disclosed. In one embodiment, the base 22 is an integral part of the housing 11, comprises a flat bottom surface about which, the device 10 is placed over a flat surface, such as over a countertop, tabletop, and the like. Notably, the shaft portion 16, the base 22, the handle portion 12 and the battery portion 14 are integral with respect to one another and define an open space 24 therebetween. The open space 24 enables the user to wrap his/her fingers around the handle portion 12 in order to securely hold and operate the massage device 10.

In one embodiment, the motor receiving portion 20 comprises a cylindrical structure and is extended through the integral portion of the massage device 10 that joins the handle portion 12 and the shaft portion 16. In one embodiment, the motor receiving portion 20 may be used as an auxiliary handle. In one embodiment, the motor receiving portion 20 houses the electric motor (not shown) that drives the shaft 18. The preferable speed of the motor is varying from, but not limited to, 2000 cycles per minute to 2800 cycles per minute and the motor preferably runs on 12-20 V power. The motor receiving portion 20 comprises a plurality of vents disposed thereon for dissipating the heat therethrough generated by the operation of the motor. The motor is disposed in operative mechanical communication with the shaft 18 whereby, the motion outputted by the motor is transmitted to the shaft 18 by means of gears, or the like. More particularly, the motion transmitted to the shaft 18 is rotary motion. In one embodiment, the motion is imparted to the shaft 18 by the motor is, but not limited to, pulsating, longitudinal to-and-fro motion. Notably, the to-and-fro motion is part of percussive massage therapy. In another embodiment, vibration is imparted to the motor to the shaft 18 wherein, the vibration is employed for vibratory therapy.

In one embodiment, the trigger 26 is hingedly disposed within a trigger hole. In one embodiment, the trigger 26 is disposed in electrical operative communication with the motor such that, actuating the trigger 26 results in the activation of the motor. In one embodiment, the trigger 26 is lockable, whereby, in the event of the motor being inactive, the user could simply press and release the trigger 26 for activating the motor.

In one embodiment, the massage device 10 further comprises a toggle switch 28, which is securely disposed on the housing 11. In one embodiment, the toggle switch 28 is configured to enable the user to change the operational modes of the massage device 10. For example, the user could change the speed of the motor according to the operational modes using the toggle switch 28.

In one embodiment, the applicator head 30 is meant to be applied over the skin of the user in order to deliver a therapeutic effect thereto. In one embodiment, the applicator head 30 is configured to threadably connected to one end of the shaft 18. In one embodiment, the applicator head 30 is configured to be vibrated and heated selectively and incrementally to provide percussion and hot therapeutic effects for the user while massaging the body, thereby effectively relieving muscle soreness. In one embodiment, the applicator head 30 is further configured to be cooled selectively and incrementally to provide percussion and cool therapeutic effects for the user while massaging the body.

In one embodiment, the applicator head 30 is filled with a cold-retaining fluid (or gel). The applicator head 30 is refrigerated prior to being applied over the skin for the cold therapy. The cold therapy is ideal for treating bruises, swollen body, etc., as cold slows down the blood flow to the injury site thereby reducing inflammation, muscle spasm, pain, swelling, and the like.

In one embodiment, the applicator head 30 is filled with a heat-retaining fluid (or gel) whereby, prior to being applied over the skin for hot therapy, the applicator head 30 is warmed using, for example, a microwave oven. Hot therapy opens up blood vessels, which in turn increase blood flow and supplies oxygen and nutrients to reduce pain in joints and relax sore muscles, ligaments, and tendons. The warmth also decreases muscle spasms and can increase range of motion. Applying superficial heat to the body improves the flexibility of tendons and ligaments, reduces muscle spasms, and alleviates pain.

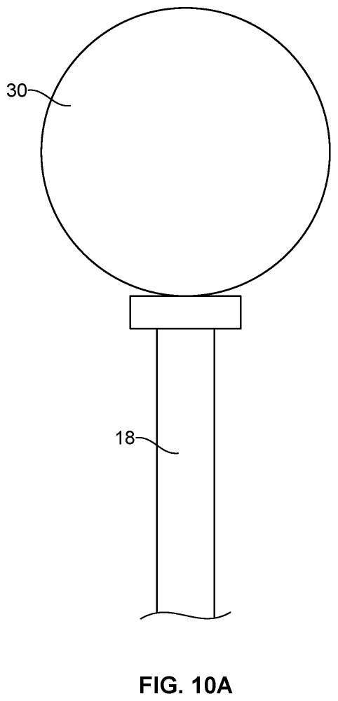

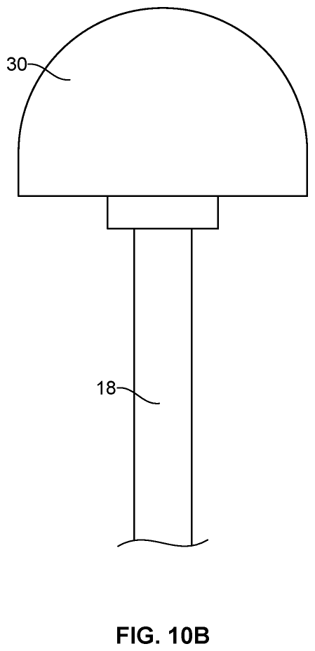

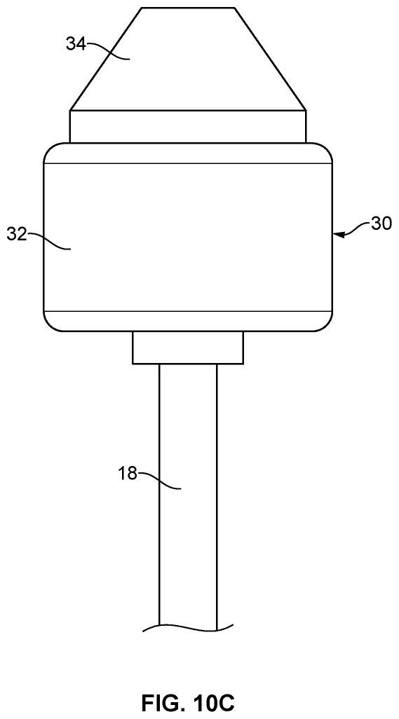

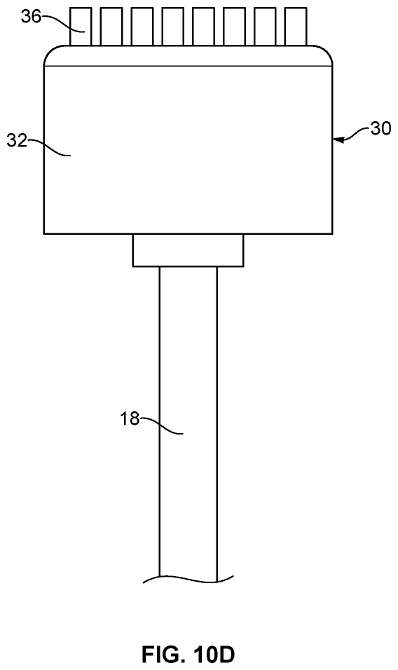

Referring to FIGS. 10A-10B, massage heads 30 of various shapes are envisioned to be used in conjunction with the massage device 10. In one embodiment, the massage heads 30 comprise various shapes include, but not limited to, a spherical, a semi-spherical, a frustoconical, and rectangular shapes. Referring to FIG. 10C, the applicator head 30 in yet another embodiment is disclosed. The applicator head 30 comprises a circular base 32 and a frustoconical section 34. The frustoconical section 34 is extended from the circular base 32 to form of the applicator head 30. In one embodiment, the applicator head 30 is configured to threadably affixed to one end of the shaft 18 of the massage device 10, thereby the user could simply fix the applicator head 30 to one end of the shaft 18.

Referring to FIG. 10D, the applicator head 30 in yet another embodiment is disclosed. In another embodiment, the applicator head 30 comprises a cylindrical section 32 and a plurality of stubby bristles 36. The stubby bristles 36 are vertically extended from the cylindrical section 32. In one embodiment, the applicator head 30 is configured to threadably affixed to one end of the shaft 18 of the massage device 10, thereby the user could simply fix the applicator head 30 to one end of the shaft 18.

The advantages of the present invention include that the massage device 10 enables the user to conveniently massage any part of the body. Massage right after training reduces lactic acid buildup and repairs micro-tears meaning less soreness and improved recovery times. The massage device 10 is inexpensive in manufacture, sturdy, efficient, quitter operation, simple to set up with minimal effort, small in size and readily transportable, and which could be used to provide a massaging effect simultaneously with either a therapeutic warming or cooling effect and/or any other therapeutic related service, depending upon the need of the user for any specific type of massage. The massage device 10 is safe to use, functions efficiently, and reliably to massage any desired part of the user's body. The shaft portion 16 is configured to rotate up to 175 degrees, thereby comfortably reaching user's back for massaging using the massage device 10. The massage device 10 is cord-free and supplied with a carrying case.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A handheld massage device, comprising:
a housing defining a base, a handle portion, a motor receiving portion, a shaft portion, and a battery portion, wherein the handle portion and the battery portion are extended vertically from both ends of the base, thereby forming an open space for enabling a user to simply hold the handheld massage device, and the motor receiving portion is perpendicularly extended at a top from the handle portion;
an electric motor securely and operatively positioned within the motor receiving portion of the housing;
an applicator head rotatably connected to the electrical motor via a shaft, wherein the applicator head is configured to be vibrated and heated selectively and incrementally to provide percussion and hot therapeutic effects for the user while massaging the body, thereby effectively relieving muscle soreness,
wherein the shaft is securely disposed within the shaft portion, which is configured to rotate up to 175 degrees, thereby enabling the user to massage the body, and
a battery securely and removably affixed within the battery portion of the housing, wherein the battery is electrically connected to the electric motor via a trigger for supplying electrical power to operate the handheld massage device.

2. The handheld massage device of claim 1, wherein the handle portion is curved at the top portion to provide space for securely disposing the trigger.

3. The handheld massage device of claim 1, wherein the trigger is configured to enable the user to operate the handheld massage device at different operational modes.

4. The handheld massage device of claim 1, wherein the trigger is an electronic touch-trigger.

5. The handheld massage device of claim 1, wherein the shaft portion is perpendicularly and rotatably extended about a centerline of the handle portion of the housing.

6. The handheld massage device of claim 1, further comprises a toggle switch, securely disposed on the housing, wherein the toggle switch is configured to enable the user to change the operational modes of the handheld massage device.

7. The handheld massage device of claim 1, further comprises an infrared sensor, securely disposed on a front side of the battery portion of the housing.

8. The handheld massage device of claim 7, wherein the infrared sensor is electrically and operatively connected to the battery via a switch and is configured to sense temperature of the body, wherein the switch is securely disposed on the handle portion of the housing.

9. The handheld massage device of claim 1, further comprises a display, securely disposed on the housing, wherein the display is electrically connected to the battery via conductors and configured to display information related to the operational modes of the handheld massage device and body temperature of the user, which is measured by the infrared sensor.

10. The handheld massage device of claim 1, wherein the housing is made of antimicrobial plastic.

11. The handheld massage device of claim 1, wherein the battery portion comprises a recess for receiving the battery, wherein the battery is a lithium-ion battery.

12. The handheld massage device of claim 1, wherein the electric motor is a brushless motor and is configured to operate at different operational modes of the handheld massage device.

13. The handheld massage device of claim 1, is further configured to use with the applicator head that is further configured to be cooled selectively and incrementally to provide percussion and cool therapeutic effects for the user while massaging the body.

14. The handheld massage device of claim 1, wherein the trigger is further configured to enable the user to turn on and turn off the handheld massage device.

15. The handheld massage device of claim 1, wherein the battery is configured to recharge using a charger, wherein the charger is connected to a power supply for charging the battery.

16. The handheld massage device of claim 1, wherein the handle portion further comprises grips on inside and outside for enabling the user to securely hold and operate the handheld massage device.
